(19) United States
(12) Patent Application Publication
(10) Pub. No.: US 2025/0309281 A1
(43) Pub. Date: Oct. 2, 2025

(54) MANUFACTURING METHOD OF FUEL CELL SEPARATOR

(71) Applicant: Honda Motor Co., Ltd., Tokyo (JP)

(72) Inventor: Suguru Omori, Saitama (JP)

(21) Appl. No.: 19/062,025

(22) Filed: Feb. 25, 2025

(30) Foreign Application Priority Data
Mar. 29, 2024 (JP) 2024-055708

(51) Int. Cl. H01M 8/0254; H01M 8/0228

(52) U.S. Cl. CPC H01M 8/0254; H01M 8/0228

(57) ABSTRACT

A manufacturing method of a fuel cell separator including pressing a separator substrate having a first surface and a second surface and made of a metal, into an uneven shape to form a gas flow path on the first surface for allowing a reaction gas to flow and a cooling flow path on the second surface for allowing a cooling medium to flow, roughening the second surface to increase a surface roughness of the second surface, and forming a coating having corrosion resistance on the first surface and the second surface after the roughening.

### CROSS-REFERENCE TO RELATED APPLICATION

This application is based upon and claims the benefit of priority from Japanese Patent Application No. 2024-055708 filed on Mar. 29, 2024, the content of which is incorporated herein by reference.

### BACKGROUND OF THE INVENTION

### Field of the Invention

This invention relates to a manufacturing method of a fuel cell separator.

### Description of the Related Art

In recent years, technological developments have been made on a fuel cell that contribute to energy efficiency in order to ensure access to energy that is affordable, reliable, sustainable and advanced by more people. As a conventional technology related to this type of fuel cell, a manufacturing method of a separator is known, in which a corrosion-resistant metal film is formed on the surface of a metal separator substrate shaped into a corrugated cross-section by press molding. Such a method is described, for example, in Japanese Unexamined Patent Publication No. 2023-071352 (JP 2023-071352 A). In the method described in JP2023-071352A, after the protrusions are formed on the separator by press molding, a metal film and a conductive film are deposited on the surface of the separator.

However, when forming protrusions by press molding, it is difficult to accurately form the top surface of the protrusions into a flat plane. Therefore, when the top surfaces of the protrusions of a pair of separators are brought into contact and incorporated into a fuel cell, the electrical resistance (contact resistance) at the contact portion of the pair of separators tends to increase, leading to a deterioration in power generation efficiency.

### SUMMARY OF THE INVENTION

An aspect of the present invention is a manufacturing method of a fuel cell separator including pressing a separator substrate having a first surface and a second surface and made of a metal, into an uneven shape to form a gas flow path on the first surface for allowing a reaction gas to flow and a cooling flow path on the second surface for allowing a cooling medium to flow, roughening the second surface to increase a surface roughness of the second surface, and forming a coating having corrosion resistance on the first surface and the second surface after the roughening.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack including a separator to which a manufacturing method of a fuel cell separator according to an embodiment of the present invention is applied;

FIG. 2 is a cross-sectional view taken along line II-II in FIG. 1;

FIG. 3 is a perspective view showing a schematic configuration of a unitized electrode assembly included in the fuel cell stack of FIG. 1;

FIG. 4 is a rear view of the separator to which the manufacturing method of the fuel cell separator according to an embodiment of the present invention is applied

FIG. 5 is a view schematically illustrating an example of a cross-sectional shape of a separator in the contact portion of a pair of plates constituting the separator;

FIG. 6 is a view schematically illustrating a cross-sectional shape of a separator in the contact portion of a pair of plates constituting the separator according to the embodiment of the present invention;

FIG. 7 is a flowchart showing a procedure of a manufacturing method of a fuel cell separator according to the embodiment of the present invention; and

FIG. 8 is a view showing specifically the manufacturing method corresponding to the flowchart of FIG. 7.

### DETAILED DESCRIPTION OF THE INVENTION

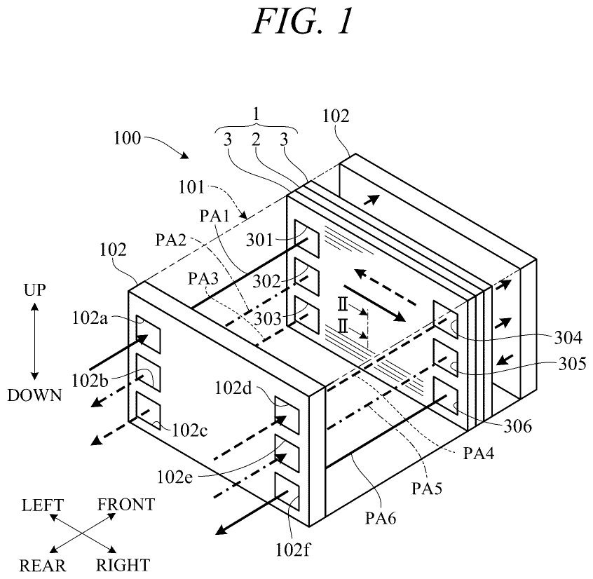

Hereinafter, an embodiment of the present invention will be described with reference to FIGS. 1 to 8. A separator. which is manufactured using a manufacturing method of a fuel cell separator according to an embodiment of the present invention, is incorporated into a fuel cell stack to form a fuel cell. The fuel cell is mounted on, for example, a vehicle and can generate electric power for driving the vehicle. First, a configuration of the fuel cell stack will be described.

FIG. 1 is a perspective view schematically showing an overall configuration of a fuel cell stack 100 which has a separator manufactured using a manufacturing method of a fuel cell separator according to the embodiment of the present invention. Hereinafter, for the sake of convenience, three-axis directions orthogonal to each other as illustrated in the drawing are defined as a front-rear direction, a left-right direction, and an up-down direction, and a configuration of each part will be described according to such definitions. The front-rear direction corresponds to the stacking direction of the fuel cell stack 100. The front-rear direction, left-right direction, and up-down direction are not necessarily the same as the front-rear direction, left-right direction, and up-down direction of the vehicle.

As shown in FIG. 1, the fuel cell stack 100 has a cell stacked body 101 formed by stacking a plurality of power generation cells 1 in the front-rear direction, and end units 102 arranged at both ends in the front-rear direction of the cell stacked body 101, and the whole of the fuel cell stack 100 has a substantially rectangular parallelepiped shape. Although not shown, the periphery of the cell stacked body 101 is covered by a substantially rectangular parallelepiped-shaped case. The length of the cell stacked body 101 in the left-right direction is longer than its length in the up-down direction. For convenience, a single power generation cell 1 is shown in FIG. 1.

The power generation cell 1 has a unitized electrode assembly (hereinafter, referred to as a “UEA”) 2 including a joint body (a membrane electrode assembly) that includes an electrolyte membrane and electrodes, and separators 3 and 3 arranged on both sides in the front-rear direction of the UEA 2 to sandwich the UEA 2. The UEA 2 and the separator 3 are alternately arranged in the front-rear direction. The UEA 2 can also be referred to as a membrane electrode structure or a membrane electrode member.

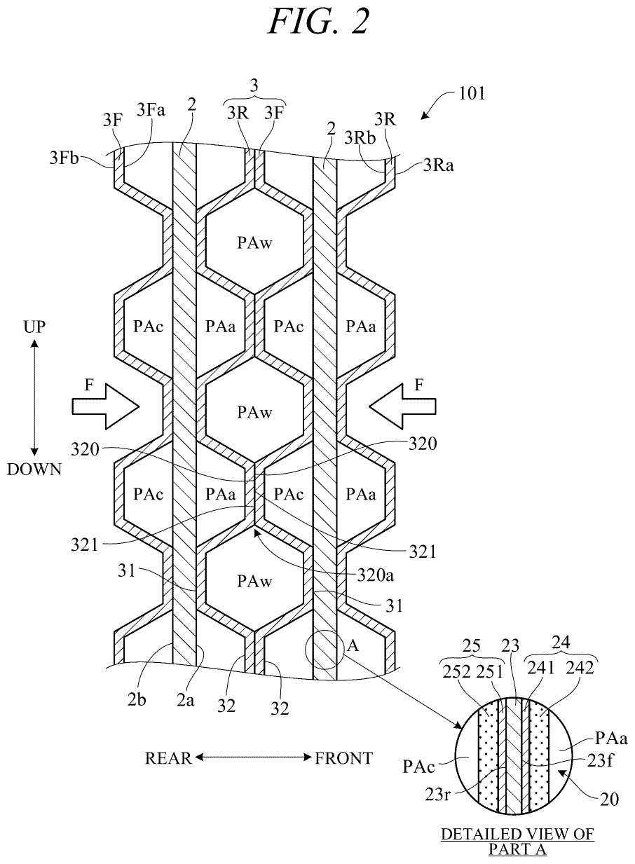

FIG. 2 is a cross-sectional view (along line II-II in FIG. 1) of the central part in the left-right direction of the cell stacked body 101. As shown in FIG. 2, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb. The front plate 3F and the rear plate 3R facing each other are joined together by welding or the like at their outer peripheral edges. Thus, the front plate 3F and the rear plate 3R are integrally joined. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling flow path PAw through which a cooling medium flows is formed. The generating surface of the power generation cell 1 is cooled by the flow of the cooling medium. Water, for example, can be used as the cooling medium. The surface (front surface 3Fa and rear surface 3Rb) of the separator facing the UEA 2 is configured with an uneven shape by press molding or the like to form a gas flow path between the surface of the separator 3 and the UEA 2. More specifically, a pair of front and rear separator 3 and 3 have a pair of front and rear protrusions 31 and 31 protruding towards the UEA 2, and a pair of front and rear recessed portions 32 and 32, which are concavely formed in continuation to the pair of front and rear protrusions 31 and 31.

The pair of front and rear protrusions 31 and 31 come into contact with the front surface 2a and the rear surface 2b of the UEA 2. In the cell stacked body 101, a compressive load F is applied in the front-rear direction during the assembly of the fuel cell stack 100, and this compressive load F is maintained after the assembly of the fuel cell stack 100 is completed. Therefore, a predetermined surface pressure due to the compressive load F acts in the front-rear direction on the UEA 2 through the protrusions 31 and 31.

Between the front surface 2a of the UEA 2 and the rear plate 3R of the separator 3 facing this front surface 2a, an anode flow path PAa through which fuel gas (anode gas) flows is formed by the recessed portion 32. Between the rear surface 2b of the UEA 2 and the front plate 3F of the separator 3 facing this rear surface 2b, a cathode flow path PAc through which oxidant gas (cathode gas) flows is formed by the recessed portion 32. The fuel gas is a gas containing hydrogen, hydrogen gas can be used, for example. The oxidant gas is a gas containing oxygen, and air can be used, for example. The fuel gas and the oxidant gas may be referred to as a reaction gas without being distinguished from each other.

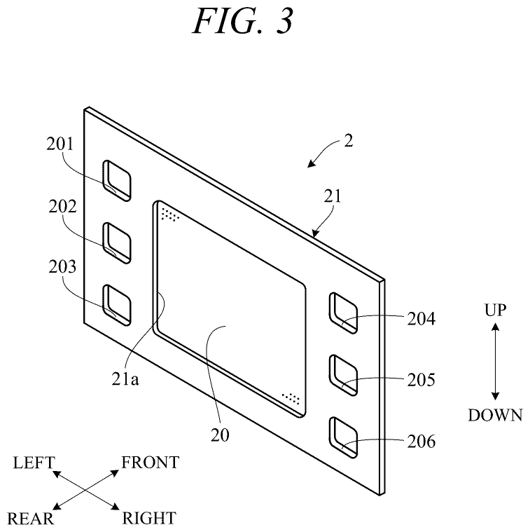

FIG. 3 is a perspective view showing a schematic configuration of the UEA 2. As shown in FIG. 3, the UEA 2 includes a substantially rectangular membrane electrode assembly (hereinafter, referred to as a “MEA”) 20 and a frame 21 that supports the MEA 20. As shown in the detailed view of part “A” in FIG. 1, the MEA 20 has an electrolyte membrane 23, an anode electrode 24 provided on a front surface 23f of the electrolyte membrane 23, and a cathode electrode 25 provided on a rear surface 23r of the electrolyte membrane 23.

The electrolyte membrane 23 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 24 has an electrode catalyst layer 241 formed on the front surface 23f of the electrolyte membrane 23 and served as a reaction field for electrode reaction, and a gas diffusion layer 242 formed on the front surface of the electrode catalyst layer 241 to spread and supply the fuel gas. An intermediate layer (underlayer) can also be provided between the electrode catalyst layer 241 and the gas diffusion layer 242. The electrode catalyst layer 241 alone may also be referred to as the anode electrode 24.

The cathode electrode 25 has an electrode catalyst layer 251 formed on the rear surface 23r of the electrolyte membrane 23 and served as a reaction field for electrode reaction, and a gas diffusion layer 252 formed on the rear surface of the electrode catalyst layer 251 to spread and supply the oxidant gas. An intermediate layer (underlayer) can also be provided between the electrode catalyst layer 251 and the gas diffusion layer 252. The electrode catalyst layer 251 alone may also be referred to as the cathode electrode 25.

In the anode electrode 24, the fuel gas (hydrogen) supplied through the anode flow path PAa is ionized by an action of a catalyst, passes through the electrolyte membrane 23, and moves to the cathode electrode side. Electrons generated at this time pass through an external circuit and are extracted as electric energy. In the cathode electrode 25, an oxidant gas (oxygen) supplied via the cathode flow path PAc reacts with hydrogen ions guided from the anode electrode 24 and electrons moved from the anode electrode 24 to generate water. The generated water gives an appropriate humidity to the electrolyte membrane 23, and excess water is discharged to an outside of the UEA 2 along the gas flow. The generated water on the cathode side also flows to the anode side by inverse spread through the electrolyte membrane 23. Therefore, the generated water is present in both the anode flow path PAa and the cathode flow path PAc.

As illustrated in FIG. 3, the frame 21 is a thin plate having a substantially rectangular shape, and is made of an insulating resin, rubber, or the like. A substantially rectangular opening 21a is provided in a central portion of the frame 21. The MEA 20 is disposed to cover the entire opening 21a and a peripheral portion of the MEA 20 is supported by the frame 21.

Three through-holes 201 to 203 penetrating the frame 21 in the front-rear direction are opened side by side in the up-down direction on the left side of the opening 21a of the frame 21. Three through-holes 204 to 206 penetrating the frame 21 in the front-rear direction are opened side by side in the up-down direction on the right side of the opening 21a of the frame 21.

As shown in FIG. 1, in the separator 3 in front of and behind the UEA 2, through-holes 301 to 306 penetrating the separators 3 in the front-rear direction are opened at positions corresponding to the through-holes 201 to 206 of the frame 21. The through-holes 301 to 306 communicate with the through-holes 201 to 206 of the frame 21, respectively. The set of the through-holes 201 to 206 and 301 to 306 communicating with each other forms flow paths PA1 to PA6 (indicated by arrows for the sake of convenience) penetrating the cell stacked body 101 and extending in the front-rear direction. The flow paths PA1 to PA6 may be referred to as manifolds. The flow paths PA1 to PA6 are connected to a manifold outside the fuel cell stack 100.

In the rear end unit 102, a plurality of through-holes 102a to 102f are opened at positions corresponding to the through-holes 201 to 206 and 301 to 306 of the cell stacked body 101, so as to penetrate the end unit 102 in the front-rear direction.

The fuel gas (anode gas) is supplied to the fuel cell stack 100 through the through-hole 102a along a flow path PA1 shown by the solid line. This fuel gas is guided to the anode flow path PAa between the UEA 2 and the rear plate 3R of the separator 3 through the through-holes 201 and 301. The fuel gas after passing through the anode flow path PAa, i.e., the fuel exhaust gas (anode off-gas), is discharged from the through-hole 102f through the through-holes 206 and 306 along a flow path PA6 shown by the solid line.

The oxidant gas (cathode gas) is supplied to the fuel cell stack 100 through the through-hole 102d along a flow path PA4 shown by the dotted line. This oxidant gas is guided to the cathode flow path PAc between the UEA2 and the front plate 3F of the separator 3 through the through-holes 204 and 304. The oxidant gas after passing through the cathode flow path PAc, i.e., the oxidant exhaust gas (cathode off-gas), is discharged from the through-hole 102c through the through-holes 203 and 303 along a flow path PA3 shown by the dotted line.

The cooling medium is supplied to the fuel cell stack 100 through the through-hole 102e along a flow path PA5 shown by the one-dot chain line. This cooling medium is guided to the cooling flow path PAw between the front plate 3F and the rear plate 3R of the separator 3 through the through-holes 205 and 305. The cooling medium after passing through the cooling flow path PAw is discharged from the through-hole 102b through the through-holes 202 and 302 along a flow path PA2 shown by the one-dot chain line. The above is the schematic configuration of the fuel cell stack 100.

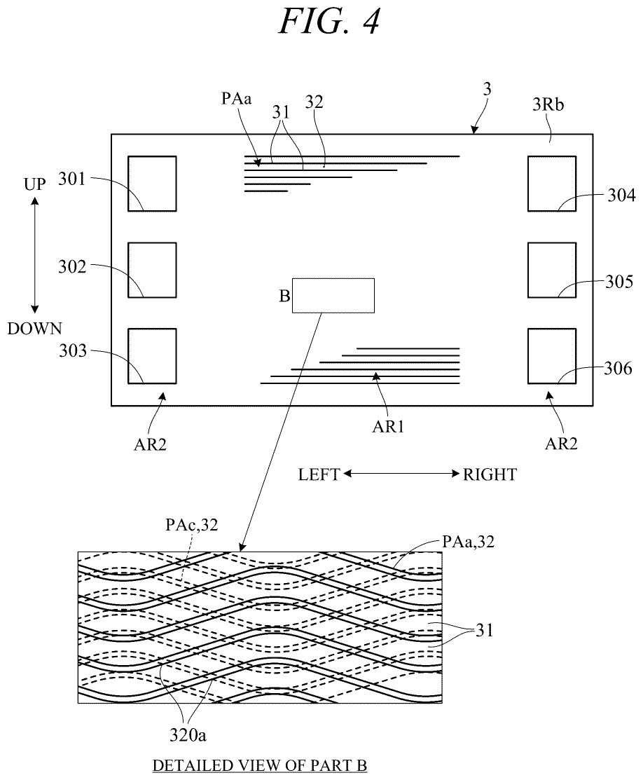

The configuration of the separator 3 will be described in more detail. FIG. 4 is a rear view (a view viewed from the rear) of the separator 3. That is, FIG. 4 is a view illustrating the rear surface 3Rb (FIG. 2) of the rear plate 3R facing the anode electrode 24 on the front surface 2a of the UEA 2.

In FIG. 4, a region facing the MEA 20 of the UEA 2, that is, a region AR1 facing the power generation surface is referred to as an active region of the separator 3, and a region AR2 other than the active region is referred to as an inactive region. The active region AR1 is an area where power generation is performed. As illustrated in FIG. 4, in the active region AR1 of the rear surface 3Rb of the rear plate 3R, although not illustrated in full, a plurality of protrusions 31 (FIG. 2) are provided to protrude rearward at equal intervals in the up-down direction over substantially the entire region.

More specifically, as shown in the detailed view of part B in FIG. 4, each of the plurality of protrusions 31 extends in the left-right direction while meandering, and a recessed portion 32 is provided between the protrusions 31 and 31 adjacent in the up-down direction. The anode flow path PAa is formed between the plurality of recessed portions 32 and the front surface 2a (FIG. 2) of the MEA 20. In the detailed view of part B, only the outline of the bottom surface of the anode flow path PAa (the bottom surface of the recessed portion 32) is indicated by a solid line.

The active region AR1 of the front surface 3Fa of the front plate 3F is also provided with a plurality of protrusions 31 (FIG. 2) protruding forward at equal intervals in the up-down direction over substantially the entire area. Each of the plurality of protrusions 31 extends in the left-right direction while meandering, and a recessed portion 32 is provided between the protrusions 31 and 31 adjacent in the up-down direction. A cathode flow path PAc is formed between the plurality of recessed portions 32 and the rear surface 2b (FIG. 2) of the MEA 20. In the detailed view of part B, only the outline of the bottom surface of the cathode flow path PAc (the bottom surface of the recessed portion 32) is indicated by a dotted line.

As illustrated in FIG. 2, the recessed portion 32 of the rear plate 3R and the recessed portion 32 of the front plate 3F become protrusions 320 when viewed from the cooling flow path PAw side. A top surface 321 of the protrusion 320, that is, the front end surface of the protrusion 320 of the rear plate 3R and the rear end surface of the protrusion 320 of the front plate 3F abut on each other. Through this contact portion 320a, a current flows between the pair of plates 3R and 3F, that is, between the power generation cells 1 and 1.

As illustrated in FIG. 4, the recessed portion 32 (protrusion 320) of the rear plate 3R and the recessed portion 32 (protrusion 320) of the front plate 3F are formed so as to be shifted in phase in the left-right direction. Therefore, the protrusion 320 of the rear plate 3R and the protrusion 320 of the front plate 3F intersect and come into contact with each other at the contact portion 320a, and the entire contact area is small.

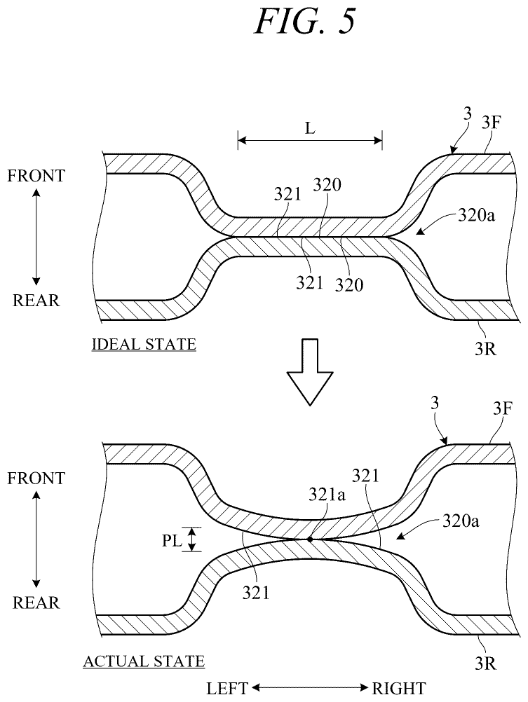

FIG. 5 is a view schematically illustrating an example of a cross-sectional shape of the separator 3 in the contact portion 320a, and illustrates an ideal state and an actual state. As illustrated in FIG. 5, in the ideal state, the top surface 321 of the protrusion 320 is a flat surface. For this reason, the flatness of the top surface 321 is small, and the top surface 321 of the protrusion 320 of the rear plate 3R and the top surface 321 of the protrusion 320 of the front plate 3F are brought into surface contact with each other over a predetermined length L.

On the other hand, since the protrusion 320 is formed by press working, in the actual state, the protrusion 320 has, for example, a substantially arc shape and protrudes toward the central portion in the left-right direction, and the flatness PL of the protrusion 320 increases. Therefore, the front plate 3F and the rear plate 3R are in point contact with each other at a contact point 321a of a part of the top surface 321 without surface contact, and the contact area is reduced. In particular, since the protrusions 320 intersect and abut each other (FIG. 4), a sufficient contact area cannot be obtained. As a result, the contact resistance increases, and the flow of the current between the pair of plates 3R and 3F is hindered.

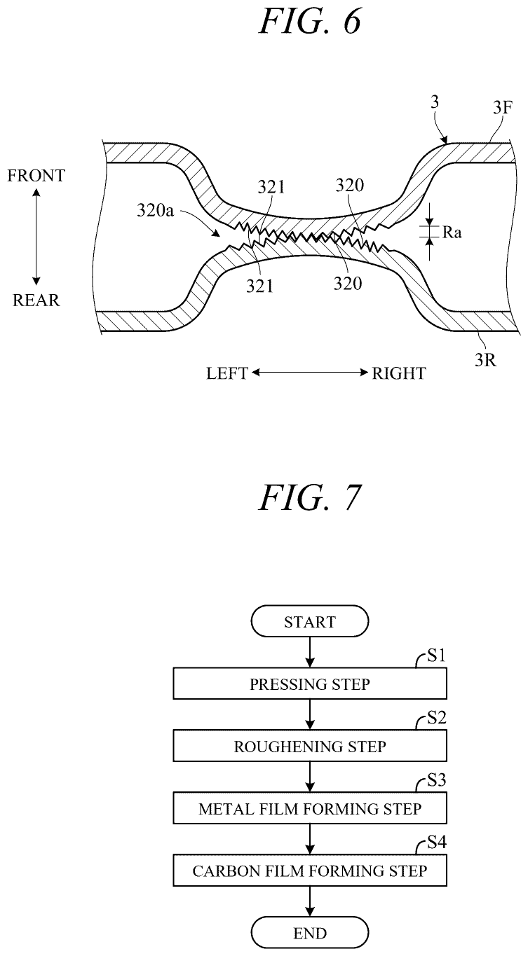

Therefore, in order to reduce the contact resistance, in the present embodiment, the contact portion 320a of the separator 3 is configured as follows. FIG. 6 is a view schematically illustrating a cross-sectional shape of the contact portion 320a of the separator 3 according to the present embodiment. As illustrated in FIG. 6, the top surfaces 321 of the pair of plates 3R and 3F are roughened to increase the surface roughness Ra, and the top surfaces 321 are formed in an uneven shape. The roughening is performed, for example, by laser processing using a laser processing machine. That is, by irradiating the top surface 321 with a laser beam, roughening (also referred to as roughening processing) is performed.

The size (length in the front-rear direction) of the uneven portion of the top surface 321 is minute. As an example, the surface roughness (arithmetic average roughness) Ra of the top surface 321 is 1 μm or more and 20 μm or less, and preferably 1 μm or more and 10 μm or less. The target surface roughness of the top surface 321 is set according to the flatness PL of the top surface 321. That is, the target surface roughness is set so as to increase as the flatness PL increases. More specifically, the target surface roughness is set to a value equal to or equivalent to the size of the flatness PL, and the top surface 321 is subjected to laser processing such that the actual surface roughness Ra becomes the target surface roughness. As the target surface roughness, the maximum height Ry or the ten-point average roughness Rz may be used instead of using the arithmetic average roughness Ra.

Roughening the top surface 321 by laser processing (increasing the surface roughness) increases the number of points in contact or causes contact between inclined surfaces extending in the front-rear direction. As a result, the contact area between the top surfaces 321 of the pair of plates 3R and 3F increases. Therefore, the contact resistance is reduced, and the flow of the current between the pair of plates 3R and 3F can be promoted.

Incidentally, when iron ions are eluted into water in the gas flow paths PAa and PAc from the gas side surface (the rear surface 3Rb of the rear plate 3R and the front surface 3Fa of the front plate 3F) of the separator 3, the iron ions may reach the electrolyte membrane 23 to cause deterioration of the electrolyte membrane 23. Therefore, in order to suppress elution of iron ions, it is necessary to apply a coating having corrosion resistance to the gas-side surface of the separator 3. On the other hand, even if iron ions are eluted from the surfaces (the front surface 3Ra of the rear plate 3R, the rear surface 3Fb of the front plate 3F) of the separator 3 on the cooling medium side, deterioration of the electrolyte membrane 23 is not caused. Therefore, from the viewpoint of preventing deterioration of the electrolyte membrane 23, coating of the surface of the separator 3 on the cooling medium side is unnecessary.

However, in the present embodiment, as described above, the top surface 321 of the separator 3 is processed so as to increase the surface roughness. Therefore, as the service period of the fuel cell becomes longer, an oxide film is formed on the top surface 321 by dissolved oxygen contained in water as a cooling medium. As a result, the contact resistance increases, and the effect of reducing the contact resistance by laser processing may be impaired. Therefore, in the present embodiment, coating is applied to the top surface 321 after laser processing in order to suppress the generation of the oxide film on the top surface 321.

Specifically, the top surface 321 is formed of a metal film (titanium film) having high corrosion resistance such as titanium or a titanium alloy by physical vapor deposition (PVD) such as sputtering, vacuum vapor deposition, or ion plating. The thickness of the titanium film is thinner than the surface roughness Ra, and is, for example, at least 85 nm or more, and preferably 90 to 100 nm on average.

Further, in order to enhance the conductivity of the separator 3, a conductive film (carbon film) of highly conductive carbon or the like is formed on the titanium film by physical vapor deposition. The thickness of the carbon film is thinner than the surface roughness Ra, and is, for example, at least 65 nm or more, preferably 70 to 75 nm on average.

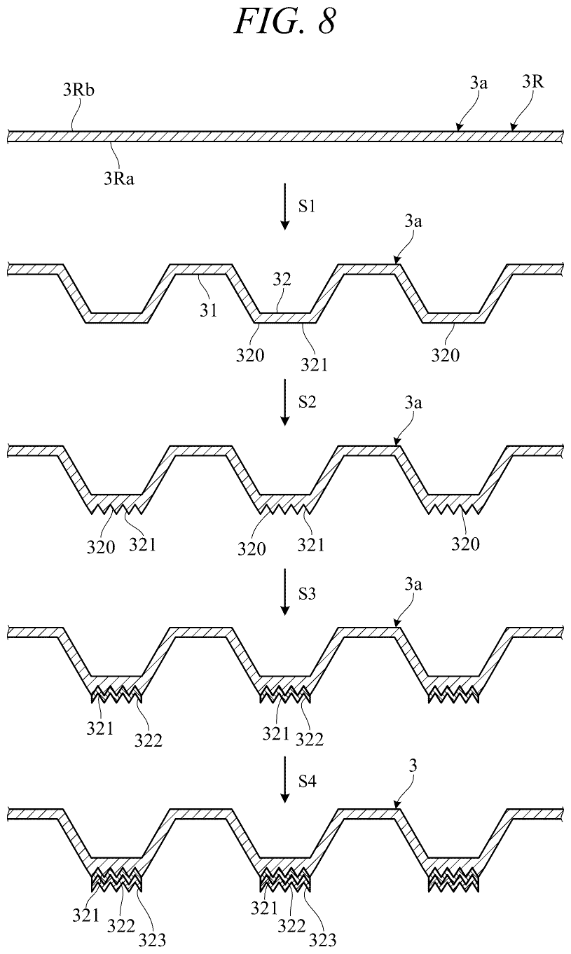

The method for manufacturing the fuel cell separator is summarized as follows. FIG. 7 is a flowchart showing a main procedure of a method for manufacturing a fuel cell separator, and FIG. 8 is an image view for explaining each procedure of FIG. 7. Hereinafter, in order to distinguish from the separator 3 after completion, the separator 3 before the carbon film is formed, that is, before completion is referred to as a separator substrate 3a. In FIG. 8, a method for manufacturing the separator will be described using the rear plate 3R, but the same applies to the front plate 3F.

As shown in FIGS. 7 and 8, first, in S1 (S: processing step), the separator substrate 3a is pressed using a pressing machine (not shown), and the protrusion 31 and the recessed portion 32 for the gas flow paths PAa and PAc are formed in the separator substrate 3a. As a result, the protrusion 320 protruding forward is formed on the front surface 3Ra of the separator substrate 3a which is the back side of the recessed portion 32 (pressing step). Although not illustrated, a protrusion for sealing and the like are simultaneously formed in the inactive region AR2 (FIG. 4) in the separator substrate 3a.

Next, in S2, the top surface 321 of the protrusion 320 is irradiated with a laser beam using a laser beam machine (not illustrated) such that the surface roughness Ra of the top surface 321 becomes the target surface roughness. As a result, the top surface 321 is roughened, and the surface roughness increases (roughening step). At this time, the position of the protrusion 320 is stored in advance in a computer, and the operation of the laser beam machine is controlled by the computer so that only the top surface 321 is irradiated with the laser beam. Thus, the processing time can be shortened.

Next, in S3, a titanium film 322 is formed as a first film on the top surface 321 after laser processing by physical vapor deposition (metal film forming step). At this time, the film forming range is limited so that the film is formed only on the top surface 321. Accordingly, the film-forming material can be saved.

Next, in S4, a carbon film 323 is formed as a second film on the surface of the titanium film 322 by physical vapor deposition (carbon film forming step). At this time, the film forming range is limited so that the film is formed only on the top surface 321. Accordingly, the film-forming material can be saved. In FIG. 8, the unevenness of the top surface 321 is exaggerated for convenience.

The rear plate 3R of the separator 3 is thus completed. The front plate 3F is also manufactured in the same manner as the rear plate 3R. After the front and rear plates 3F and 3R are manufactured, the pair of plates 3F and 3R is welded and integrated to form the separator 3. Although the description is omitted, the method for manufacturing the separator 3 includes a polishing step and the like.

According to the present embodiment, the following operations and effects can be achieved.
(1) A method for manufacturing a fuel cell separator (for example, the rear plate 3R) includes: a pressing step (S1) of pressing a metallic separator substrate 3a having a rear surface 3Rb and a front surface 3Ra into an uneven shape so as to form an anode flow path PAa through which fuel gas flows on the rear surface 3Rb and form a cooling flow path PAw through which a cooling medium flows on the front surface 3Fa; a roughening step (S2) of roughening the front surface 3Ra so as to increase surface roughness Ra of the front surface 3Ra (particularly, the top surface 321); and a metal film forming step (S3) of forming a titanium film having corrosion resistance on the rear surface 3Rb, and the front surface 3Ra (particularly, the top surface 321) after the roughening step (FIGS. 7 and 8).

With this configuration, it is possible to reduce the contact resistance at the contact portion 320a with which the pair of plates 3R and 3F abuts with the cooling flow path PAw interposed therebetween. As a result, the flow of the current between the plates 3R and 3F can be promoted, and accordingly, the number of stacked power generation cells 1 necessary for obtaining a predetermined power generation amount can be reduced, and efficient power generation can be performed. As a result, cost can be reduced and fuel cell stack 100 can be downsized.
(2) The roughening step includes irradiating the front surface 3Ra, particularly the top surface 321, of the rear plate 3R with a laser beam. As a result, the predetermined range of the top surface 321 can be easily processed to have the desired surface roughness Ra.
(3) The pressing step includes forming the protrusion 320 protruding toward the front surface 3Ra on the separator substrate 3a of the rear plate 3R (FIG. 8). The roughening step includes roughening the top surface 321 of the protrusion 320 in the front surface 3Ra (FIG. 8). As a result, since the range of laser processing is narrowed, the roughening step can be completed in a short time, and the separator 3 can be efficiently manufactured.
(4) The film forming step includes forming a titanium film having corrosion resistance on the rear surface 3Rb of the rear plate 3R, and the front surface 3Ra (particularly, the top surface 321) after the roughening step, and then forming a carbon film having conductivity (S4) (FIGS. 7 and 8). As a result, the conductivity between the plates 3R and 3F is further improved together with the decrease in contact resistance.
(5) The roughening step includes roughening the front surface 3Ra (particularly, the top surface 321) of the rear plate 3R so as to have a surface roughness of 1 μm or more and 20 μm or less. As a result, it is possible to satisfactorily increase the contact area of the contact portion 320a that might come into contact in a point contact state by press working.

The above embodiment can be modified in various forms. Below, some modified examples are described. In the above embodiment, gas flow paths PAa and PAc for fuel gas and oxidant gas are formed on the rear surface 3Rb (a first surface) of the rear plate 3R and the front surface 3Fa (a first surface) of the front plate 3F, and cooling flow path PAw for the cooling medium is formed on the front surface 3Ra (a second surface) of the rear plate 3R and the rear surface 3Fb (a second surface) of the front plate 3F by pressing the separator substrate into an uneven shape, but the shapes of the flow paths PAa, PAc, and PAw are not limited to those described above.

In the above embodiment, as a roughening process, a laser beam is irradiated only on the part of the front surface 3Ra of the rear plate 3R that contacts the front plate 3F, but the laser beam may be irradiated on the entire front surface 3Ra. In the above embodiment, the roughening process is performed by laser processing, but it may also be performed by other processing methods. In the above embodiment, as a film forming process (metal film forming process, carbon film forming process), a corrosion-resistant titanium film 322 and a conductive carbon film 324 are formed only on the top surface 321 of the protrusion 320 on the front surface 3Ra of the rear plate 3R, but the films (coating) may also be formed on other portions. As a film-forming process, only the formation of a corrosion-resistant film may be performed.

In the above embodiment, an example of applying the fuel cell stack 100 to a vehicle is described, but the fuel cell stack including a separator manufactured by the manufacturing method according to the embodiment of the present invention can also be applied to various industrial machines in addition to a moving body other than a vehicle such as an aircraft or a boat, a robot, and the like.

The above embodiment can be combined as desired with one or more of the above modifications. The modifications can also be combined with one another.

According to the present invention, it is possible to reduce an electrical resistance at a contact portion of a pair of separators, enabling efficient power generation.

Above, while the present invention has been described with reference to the preferred embodiments thereof, it will be understood, by those skilled in the art, that various changes and modifications may be made thereto without departing from the scope of the appended claims.

What is claimed is:

1. A manufacturing method of a fuel cell separator comprising:
pressing a separator substrate having a first surface and a second surface and made of a metal, into an uneven shape to form a gas flow path on the first surface for allowing a reaction gas to flow and a cooling flow path on the second surface for allowing a cooling medium to flow;
roughening the second surface to increase a surface roughness of the second surface; and
forming a coating having corrosion resistance on the first surface and the second surface after the roughening.

2. The manufacturing method according to claim 1, wherein
the roughening includes irradiating the second surface with a laser beam.

3. The manufacturing method according to claim 1, wherein
the pressing includes forming a protrusion protruding toward a side of the second surface on the separator substrate, and
the roughening including roughening a top surface of the protrusion on the second surface.

4. The manufacturing method according to claim 1, wherein
the forming including forming a first coating having the corrosion resistance on the first surface and the second surface after the roughening, and subsequently forming a second coating having conductivity.

5. The manufacturing method according to claim 4, wherein
a thickness of the first coating and a thickness of the second coating are thinner than the surface roughness of the second surface after the roughening.

6. The manufacturing method according to claim 1, wherein
the roughening including roughening the second surface so as to have a surface roughness between 1 μm and 20 μm.
